(19) United States
(12) Patent Application Publication
(10) Pub. No.: US 2011/0134740 A1
(43) Pub. Date: Jun. 9, 2011

(54) Optical Device, Optical Recording Head and Optical Recording Device

(76) Inventors: Koujirou Sekine, Osaka (JP); Hiroaki Ueda, Osaka (JP); Manami Kuiseko, Osaka (JP); Naoki Nishida, Osaka (JP); Hiroshi Hatano, Osaka (JP); Kou Osawa, Osaka (JP)

(21) Appl. No.: 13/057,666

(22) PCT Filed: Jul. 13, 2009
(86) PCT No.: PCT/JP2009/062669

§ 371 Date: Feb. 4, 2011

(30) Foreign Application Priority Data
Aug. 8, 2008 (JP) 2008-205286

(51) Int. Cl. G11B 7/00; G02B 27/44

(52) U.S. Cl. 369/100; 359/573; G9B/7

(57) ABSTRACT

Provided is an optical device configured to makes it possible to enhance use efficiency of light. An optical device is provided with an optical element to deflect incident light and a fixation member on which the optical element is fixed. The optical element includes a reflective surface and a diffraction grating surface that deflects the incident light. The optical element is fixed on the fixation member to restrain displacement in accordance with temperature changes at portions thereof other than the reflective surface and the diffracting grating surface in such a condition that displacement is caused without restraint be temperature changes at the reflective surface and the diffraction grating surface. A change of the incident light in the deflection angle due to an inclination change by the reflective surface and the diffracting grating surface is suppressed by a change in a diffraction angle due to a periodical change in the diffraction grating by the displacement of the diffraction grating surface.

### FIELD OF THE INVENTION

The present invention relates to an optical device, optical recording head and optical recording device.

### DESCRIPTION OF RELATED ART

In recent years, there is a trend moving toward increasingly greater densities in an information recording medium. Various forms of recording methods have been proposed. The heat-assisted magnetic recording method is one of such proposed methods. To increase densities in the magnetic recording method, the size of each magnetic domain must be reduced. To ensure stable saving of data, it is necessary to use a recording medium made of the material characterized by greater coercive force. Such a recording medium requires a strong magnetic field to be generated at the time of writing. However, the size of the magnetic field is limited in a smaller head corresponding to the magnetic domain reduced in size.

In the heat-assisted magnetic recording method, the recording medium is locally heated at the time of recording so that magnetic weakening occurs. When the coercive force has been reduced, recording is performed. After that heating is suspended, and the stability of the recorded magnetic bit is ensured by natural cooling.

The recording medium is preferably heated instantaneously in the heat-assisted magnetic recording method. Contact between the healing mechanism and recording medium is not permitted. This requires heating to be conducted by absorption of light in most cases. The method of using light for heating is referred to as a photo-assisted method. When high-density recording is used in the photo-assisted method, it is necessary to utilize a minute optical spot with a wavelength without exceeding the wavelength of the light to be used.

To meet this requirement, a proposal has been made of an optical head that uses the nearby field light (also referred to as near field light) generated from an optical opening with a size without exceeding the wavelength of an incident light (Patent Literature 1).

The optical recording head described in Patent Literature 1 is provided with a writing magnetic pole, and a waveguide having a core layer adjacent to this writing magnetic pole and a clad layer. The core layer is provided with a diffraction grating for introducing light into this core layer. If a laser beam is applied to this core layer, the laser beam is coupled to the core layer. The laser beam coupled to the core layer converges to the focal point located close to the tip end of the core layer. The recording medium is heated by the light emitted from the tip end and writing is performed by the writing magnetic pole. The element having the waveguide with light converging function is called the Planar Solid Immersion Mirror (PSIM). The PSIM described in Patent Literature 1 is equipped with a diffraction grating, as described above. When consideration is given to the percentage of the amount of light (light usage efficiency) converged on the PSIM relative to the amount of light entering this diffraction grating, an appropriate angle is present as the incident angle of the light entering the diffraction grating.

### EARLIER LITERATURE

### Patent Literature

Patent Literature 1: U.S. Pat. No. 6,944,112

### SUMMARY OF THE INVENTION

### Problems to be Solved by the Invention

However, the Patent Literature 1 merely describes that the light of the light source is applied by being inclined with respect to the diffraction gating, without any reference to a specific method of leading the light of the light source to the diffraction grating.

In view of the problems described above, it is an object of the present invention to provide an optical device, optical recording head and optical recording device capable of enhancing the efficiency of using light.

### Means for Solving the Problems

The above problems can be solved by the following Structures:

1. An optical device including; an optical element for deflecting an incident light and a fixing member for fixing the optical element; wherein the optical element has a reflective surface for deflecting the incident light and a diffraction grating surface for deflecting the incident light; the optical element is fixed on the fixing member so as to restrain displacement due to a temperature change at portions thereof other than the reflective surface and the diffracting grating surface of the optical element, under a condition that a displacement due to the temperature change on the reflective surface and the diffraction grating surface is kept in a free state; and, a change in the deflecting angle of the incident light caused by a change in inclination due to the displacement on the reflective surface and the diffraction grating surface is suppressed by a change in the diffraction angle caused by a change of the period of the diffraction grating due to the displacement in the diffraction grating surface.

2. The optical device described in Structure 1 wherein a thermal expansion coefficient of a material constituting the fixing member is smaller than a thermal expansion coefficient of a material constituting the optical element.

3. The optical device described in Structure 2 wherein the material of the fixing member is metallic and the material of the optical element is resinous.

4. The optical device described in any one of the aforementioned Structures 1 through 3 wherein a surface of the optical element allowing entry of the incident light is fixed to the fixing member.

5. The optical device described in any one of the aforementioned Structures 1 through 3 wherein the optical element further comprises a columnar member with a surface allowing entry of the incident light; the reflective surface and the diffraction grating surface is provided at a position for receiving the light which passes through the columnar member; and the optical element is fixed to the fixing member on a side surface of the columnar member.

6. The optical device described in Structure 5 wherein, around the columnar member, a frame member made of the material having a thermal expansion coefficient smaller than a thermal expansion coefficient of the material constituting the optical element is covered in contact with the side surface of the columnar member.

7. An optical recording head for optically recording information on a recording medium, wherein the optical recording head includes; a slider provided with a light propagation element for irradiating the recording medium with light a suspension for supporting the slider so as to move the slider relative to the recording medium; and an optical device described in Structure 4; wherein the fixing member is fixed to the suspension, and the optical element allows a deflected light to enter the light propagation element.

8. An optical recording head for optically recording information on a recording medium, wherein the optical recording head includes; a slider provided with a light propagation element for irradiating the recording medium with light; a suspension for supporting the slider so that the slider can be moved relative to the recording medium; and an optical device described in Structure 5 or 6; wherein the fixing member is the suspension, and the optical element allows a deflected light to enter the light propagation element.

9. The optical recording head described in Structure 7 or 8 wherein the light propagation element further includes; a waveguide for propagating light; and a grating coupler for coupling light into the waveguide; and the optical element allows light to enter the grating coupler.

10. An optical recording device includes; a light source; the optical recording head described in any one of the aforementioned Structures 7 through 9, allowing the light of the light source to enter the optical element; and the recording medium.

### Effects of the Invention

The present invention suppresses the deflecting angle of light being changed by the temperature change, thereby enhancing the efficiency of using light and ensures stable optical recording.

### BRIEF DESCRIPTION OF THE DRAWINGS

FIG. 1 is a schematic configuration diagram representing an optical recording device provided with a photo-assisted magnetic recording head in an embodiment of the present invention;

FIG. 2 is a diagram representing the schematic configuration of an optical recording head;

FIG. 3 is a front view representing the light propagation element;

FIG. 4 is a cross sectional view representing the light propagation element;

FIG. 5 is a cross sectional view representing the prism 50A and its surroundings;

FIG. 6 is a cross sectional view representing the prism 50B and its surroundings;

FIG. 7 is a cross sectional view representing the prism 50C and its surroundings;

FIG. 8 is a cross sectional view representing the prism 50D and its surroundings;

FIG. 9 is a diagram showing the prism 50A as viewed from the light inputting direction;

FIG. 10 is a diagram showing an example of the plasmon antenna;

FIG. 11 is a cross sectional view explaining the color correction at the time of wavelength fluctuation due to the prism equipped with a diffraction grating;

FIG. 12 is a cross sectional view showing the prism 50L and the periphery thereof in an reference example; and

FIG. 13 is a diagram showing the schematic configuration of an optical recording head in a reference example.

### DESCRIPTION OF THE PREFERRED EMBODIMENT

The following describes reference examples with reference to FIG. 13 prior to describing the embodiments of the present invention:

FIG. 13 is a diagram showing the schematic configuration of an optical recording head and periphery thereof in a reference example.

In FIG. 13, the reference numeral 2 is a recording medium, the reference numeral 4 is a suspension supported by the arm 5 provided rotatably in the direction of tracking, and the reference numeral 3 is an optical recording head provided on the tip end of the suspension 4. A light source 10 such as an optical fiber and a lens 12 are fixed on the arm 5, and the light of the light source 10 is emitted as parallel light from the lens 12.

The optical recording head 3 is provided with a slider 30 moving relative to a disk 2 as a recording medium. A light propagation element 20 such as a PSIM that propagates to the disk 2 the light 10a from the light source 10 is installed on the side surface of the slider 30. Light 10a is applied to the slider 30 equipped with the light propagation element 20, approximately from the lateral direction.

To ensure effective propagation of the light 10a to the disk 2, the light 10a from the light source 10 must be coupled effectively to the light propagation element 20. A diffraction grating is installed at the position where the light of the light propagation element 20 is applied. The light entering the diffraction grating is coupled to the waveguide. To ensure effective connection of the light entering the diffraction grating to the waveguide, the incident angle of the light entering the diffraction grating must be set to a prescribed optimum angle. This requires the prism 50 to be arranged on the optical path of the light 10a. The light 10a is deflected by the prism 50 to have a prescribed optimum angle.

The light source 10 emits light from the outgoing end of the optical fiber, i.e., from a semiconductor laser (not illustrated). In the semiconductor laser, in the Fabry-Perot reflection type, for example, a so-called mode hop phenomenon occurs if there is a temperature change, and the oscillation waveform undergoes fluctuation. The diffraction angle will be changed if there is a change in the wavelength of the light entering the diffraction grating of the light propagation element 20. This will cause the optical coupling efficiency of the light to be reduced. To prevent the optical coupling efficiency from being reduced, the incident angle of the light propagation element 20 to the diffraction grating can be changed in response to waveform changes.

The prism 50 is provided with a diffraction grating to modify the incident angle of the light entering the light propagation element 20 appropriately in response to the change in wavelength. If there is a change in the wavelength of the light entering the diffraction grating of the prism 50, the diffraction grating is changed in response to the wavelength, and the angle of the light emitted from the prism 50 can be changed. This can be used to make the change in the outgoing angle depending on the wavelength of the prism 50 and the change in the incoming angle depending on the wavelength of the light propagation element 20 match. This matching ensures that the light entering the prism 50 is coupled with the light propagation element 20 as if there were no fluctuation in wavelength.

However, if there is a change in the ambient temperature, the configuration of the prism 50 may be subject to change in response to the thermal expansion coefficient. If the configuration of the prism 50 is changed, there will be a change in the deflecting angle of the output light relative to the incoming light 10a. This may reduce the efficiency of the light 10a being coupled to the light propagation element 20.

The embodiment of the present invention to be described below solves the problem in the reference example.

The following describes the optical device, optical recording head and optical recording device as embodiments of the present invention. It should be noted that the present invention is not restricted to these embodiments. The same or corresponding portions in embodiments will be assigned with the same numerals of reference, and will not be described as appropriate to avoid duplication.

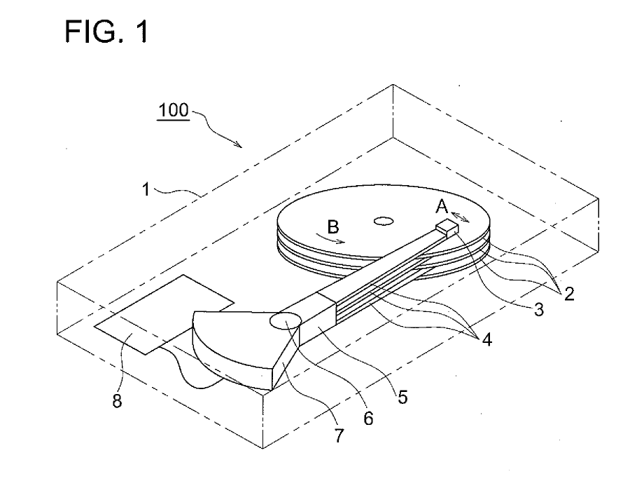

FIG. 1 is a schematic configuration diagram representing an optical recording device (e.g., hard disk device) provided with a photo-assisted magnetic recording head in an embodiment of the present invention. This optical recording device 100 has the following items 1 through 6 incorporated in an enclosure 1:

(1) Recording disk (recording medium) 2

(2) Suspension 4 supported by the arm 5 mounted rotatably in the direction of arrow A (tracking direction) using the spindle 6 as a fulcrum

(3) Tracking actuator 7 mounted on the arm 5

(4) Photo-assisted magnetic recording head (hereinafter referred to as “optical recording head 3”) mounted on the tip end of the suspension 4 through coupling member 4a

(5) Motor for rotating the disk 2 in the direction of arrow B (not illustrated) 9736

(6) Control section 8 for controlling the tracking actuator 6, motor, light being applied in response to the writing information to be recorded on the disk 2, and optical recording head 3 for generation of magnetic field.

In the optical recording device 100, the optical recording head 3 makes a relative movement levitating on the disk 2.

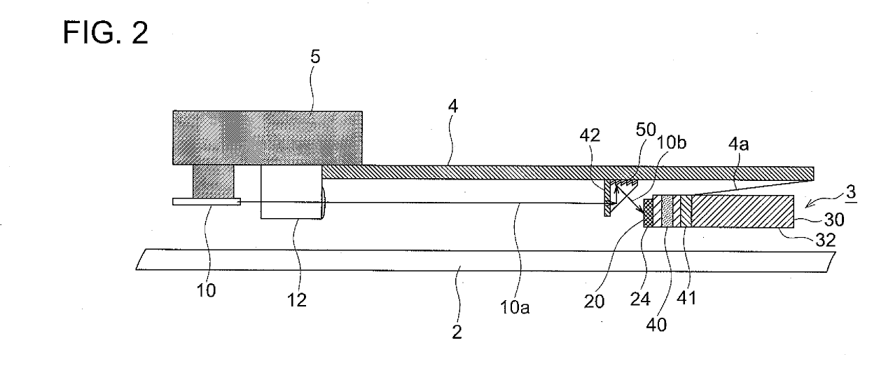

FIG. 2 schematically shows the configuration of the optical recording head 3 as viewed from the side surface. The optical recording head 3 is an optical recording head that uses light to record information on the disk 2, and includes a slider 30, light propagation element 20, magnetic recording section 40, magnetic reproduction section 41, and prism 50 as an optical element The aforementioned PSIM is used as a light propagation element 20.

The slider 30 moves relative to the disk 2 as a magnetic recording medium while levitating. The presence of dust or damage on the disk 2 may cause contact between them. To minimize the abrasion possibly caused by the contact, the slider is preferably made of a highly abrasion-resistant hard material. For example, it is preferred to use a ceramic material containing Al₂O₃ characterized by smaller thermal expansion coefficient such as an AltiC, zirconium or TiN. To prevent abrasion, it is good practice to provide surface treatment, thereby increasing the abrasion resistance on the surface on the side of the disk 2 of the slider 30. For example, use of a DLC (Diamond Like Carbon) coat enhances the light transmittance, and provides the highest degree of hardness (Hv greater than 3000) second only to diamond.

The surface facing the disk 2 is provided with an air bearing surface 32 (also referred to as “ABS”) to enhance levitation characteristics.

Levitation of the slider 30 requires stability to be ensured in close proximity to the disk 2. An adequate pressure to suppress the force of levitation must be applied to the slider 30. Thus, the suspension 4 used to support the slider 30 is provided with a function of applying an adequate pressure for suppressing the force of levitation of the slider 30, in addition to the function of tracking the optical recording head 3.

At the optical fiber output end, the light source 10 is fixed to the arm 5 together with the lens 12 equipped with a plurality of lenses for ensuring that the light emitted from the light source 10 is converted into parallel light. A laser element (semiconductor laser) that emits parallel light can be used as the light source 10.

In the optical recording head 3, a light propagation element 20 is installed on the side surface of the slider 30 facing the light source 10, approximately perpendicular to the recording surface of the disk 2.

The light 10a enters the prism 50 from the lens 12. The incoming light is deflected to a prescribed angle by the prism 50 so that light effectively enters the light propagation element 20. The light deflected to a prescribed angle as the light 10b coming from the prism 50 enters the light propagation element 20 and is coupled to the light propagation element 20. The light coupled to the light propagation element 20 goes to the bottom end surface 24 of the light propagation element 20 and is led to the disk 2 as irradiating light for heating the disk 2.

When the light from the bottom end surface 24 is applied to the disk 2 as a small optical spot, there is a temporary increase in temperature on the light-exposed portion of the disk 2, with the result that coercive force of the disk 2 is reduced. Then the magnetic recording section 40 allows magnetic information to be written on the portion wherein coercive force is reduced. The magnetic reproduction section 41 for reading the magnetic recorded information written to the disk 2 is provided immediately after the magnetic recording section 40. However, this magnetic reproduction section 41 can be mounted immediately before the light propagation element 20.

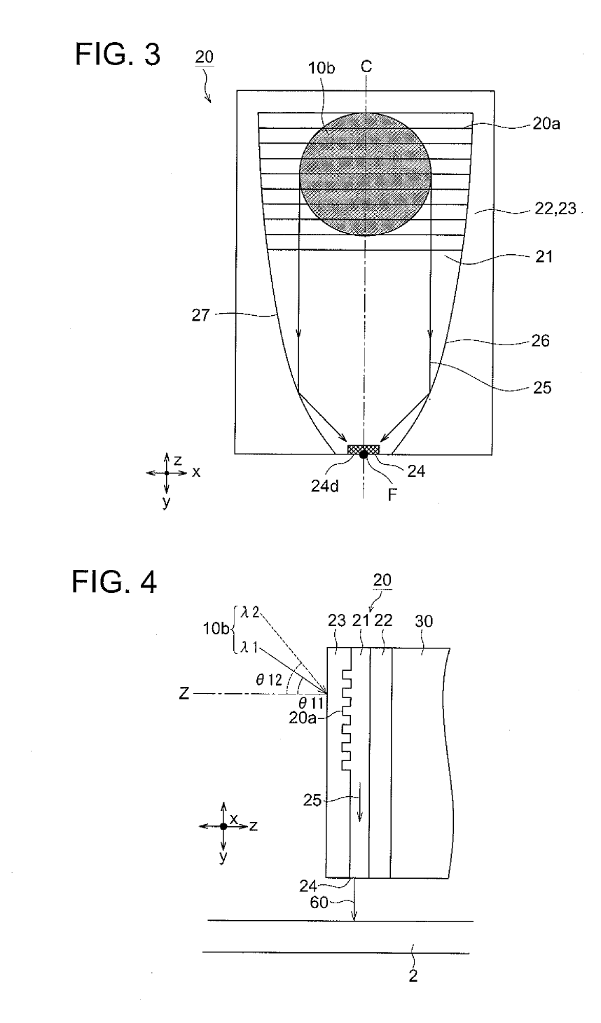

FIG. 3 schematically represents the front view of the light propagation element 20. FIG. 4 schematically shows the cross sectional view in the axis C of FIG. 3. The light propagation element 20 includes a core layer 21 constituting the waveguide, a lower clad layer 22, and an upper clad layer 23. The core layer 21 is provided with the diffraction grating 20a (also called the grating coupler) for ensuring that the light 10b corning from the prism 50 is coupled with the core layer 21. In FIG. 3, the light 10b is shown as an optical spot. The waveguide can be formed of a plurality of layers of substances having different refractive index. The refractive index of the core layer 21 is greater than that of the lower clad layer 22 or upper clad layer 23. The difference in the refractive indexes is used to form the waveguide. The light in the core layer 21 is trapped inside the core layer 21, and is efficiently led to the arrow mark 25 to reach the bottom end surface 24.

The refractive index of the core layer 21 preferably lies in the range of about 1.45 through 4.0, and the refractive indexes of the lower clad layer 22 and upper clad layer 23 preferably lie in the range of about 1.0 through 2.0.

The core layer 21 is formed of Ta₂O₅, TiO₂, ZnSe and others, and may have a thickness ranging from about 20 nm through 500 nm. The lower clad layer 22 and upper clad layer 23 are formed of SiO₂, air, Al₂O₃ and others, and may have a thickness ranging from about 200 nm through 2000 nm.

The core layer 21 is provided with side surfaces 26 and 27 wherein the contour of the outer peripheral surface is formed in a parabola, these side surfaces 26 and 27 being formed to reflect the light coupled by the diffraction grating 20a, toward the focal point F for the purpose of converging this light to the focal point F. In FIG. 3, the bilaterally symmetric center axis of the parabola is represented by axis C (a line passing through the focal point F perpendicular to the directrix (not illustrated)), and the focal point of the parabolic line is shown as the focal point F. The side surfaces 26 and 27 can be provided, for example, with such a reflecting substance as gold, silver, aluminum or the like, thereby reducing the loss of light reflection.

The bottom end surface 24 of the core layer 21 of the waveguide is manufactured in a planer shape with the tip end of the parabola apparently trimmed off. The light 60 from the focal point F exhibits abrupt diffusion. Thus, if the bottom end surface 24 is manufactured in a planer form, the focal point F is preferably arranged closer to the disk 2. Further, the focal point F can be formed on the bottom end surface 24.

A plasmon antenna 24d for nearby field light generation is installed at the focal point F of the core layer 21 or in the vicinity thereof. FIG. 10 shows a specific example of the configuration of the plasmon antenna 24d.

In FIG. 10, (a) indicates the plasmon antenna 24d made up of a triangular planer metallic thin film (wherein the material is exemplified by aluminum, gold and silver), and (b) represents the plasmon antenna 24d made up of a bow-tie type planer metallic thin film (wherein the material is exemplified by aluminum, gold and silver). Both of these antennas have an apex P with a curvature radius of 20 nm or less. Further, (c) shows a plasmon antenna 24d made up of a planer metallic thin film (wherein the material is exemplified by aluminum, gold and silver) equipped with an opening. This antenna has an apex P with a curvature radius of 20 nm or less.

If light acts on the plasmon antenna 24d, nearby field light is generated close to the apex P, and recording or reproduction can be performed using the light of very small spot size. To be more specific, when a plasmon antenna 24d is provided at the focal point F of the core layer 21 or in the vicinity thereof, and a local plasmon is generated, the size of the optical spot formed at the focal point can be further reduced. This provides advantages in high density recording. It should be noted that the apex P of the plasmon antenna 24d is preferably located at the focal point F.

In case of the light 10b emitted from the diffraction grating 20a and photo-coupled to the waveguide, the optimum incident angle of the light entering the diffraction grating 20a characterized by the highest photo-coupling efficiency is determined by the effective refractive index of the waveguide mode of the core layer 21 and the period of the diffraction grating 20a. The optimum incident angle depends on the wavelength of the incident light as well. FIG. 4 shows this angle as incident angle θ11 for wavelength λ1 and as incident angle θ12 for wavelength λ2. In FIG. 4, the symbol Z indicates the normal line on the light entering surface of the diffraction grating 20a. The same normal line will be used in the following drawings. Here assume that λ1>λ2 . . . (1). This gives θ11<θ12 . . . (2). To be more specific, an increase in the wavelength increases the diffraction grating, and this reduces the optimum incident angle to the diffraction grating 20a.

When consideration is given to the photo coupling efficiency, the period of the diffraction grating 20a to be used is preferably such that the second- or third-order light is generated. The period is approximately in the range from 0.5 through five times the wavelength. In this case, the permissible incident angle range in a certain wavelength is preferably about ±0.1 degree, when consideration is given to reduction in the photo-coupling efficiency.

In the meantime, when the Fabry-Perot type semiconductor laser is used as the light emitted from the light source 10, the wavelength of the light will be increased with a rise of temperature. If the temperature to be used lies in the range from 0 through 60 degrees Celsius and the fluctuation in the wavelength of the semiconductor laser lies in the range between ±10 nm, the fluctuation of the aforementioned optimum incident angle will be about 0.3 degrees, and this exceeds the aforementioned permissible incident angle range.

If the fluctuation in the optimum incident angle has exceeded the permissible incident angle range due to fluctuation of the wavelength, the photo coupling efficiency will be reduced, even if there is no fluctuation in the positional relationship between the diffraction grating 20a due to mechanical fluctuation and the light 10b to be applied thereto, for example. To solve this problem, the incident angle of the light entering the diffraction grating 20a must be changed in response to the fluctuation in wavelength. To permit this change, the prism 50 is provided with a diffraction grating.

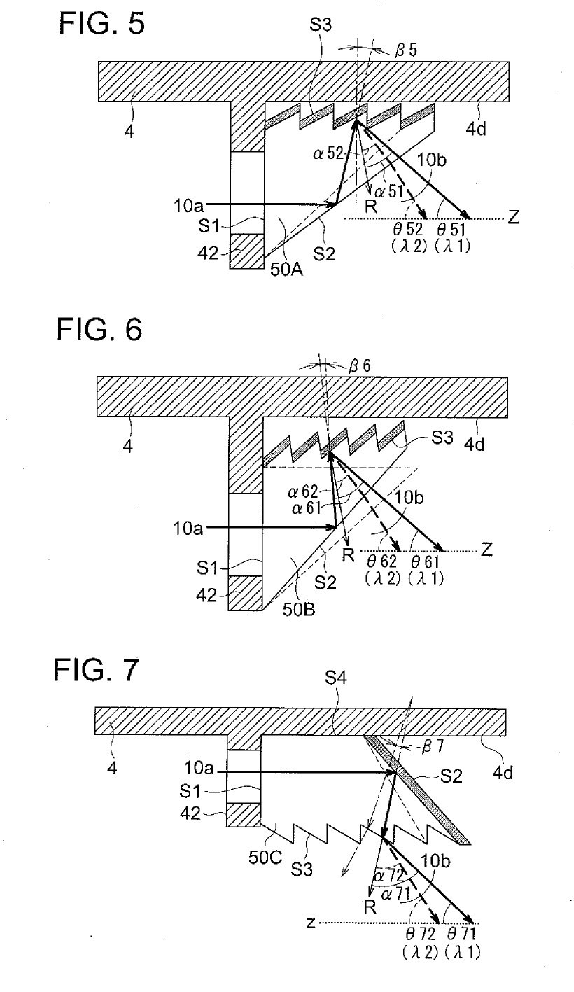

The reference numeral 50 is used to collectively indicate the prism that deflects the light 10a from the light source 10 and emits the light 10b to be coupled with the light propagation element 20. To illustrate the specific examples of the prism 50, FIGS. 5 through 8 give the cross sectional views each representing the prisms 50A, 50B, 50C and 50D with the peripheral portions thereof.

Prisms 50A, 50B, 50C and 50D can be produced by the injection molding method or press molding method using the thermoplastic resin as the material, for example. Thermoplastic resin can be exemplified by ZEONEX (registered trademark) 480R (with a refractive index of 1.525, made by Nippon Zeon Co., Ltd.), PMMA (polymethyl methacrylate, e.g., SUMIPEX (registered trademark) MGSS with a refractive index of 1.49, made by Sumitomo Chemical Co., Ltd.), and PC (polycarbonate, e.g., PANLITE (registered trademark) AD5503 with a refractive index of 1.585, made by Teijin Chemicals Ltd.). Further, these prisms can be manufactured by press molding technique using glass as a material.

Referring to FIG. 11 showing the cross section, the following describes the color correction in an ideal prism 50K having the same configuration as the prism 50A without any thermal expansion coefficient. The description using the prism 50A without any thermal expansion coefficient refers to the state prior to temperature rise in the subsequent description of the prisms 50L and 50A through 50D.

The surface S3 of the prism 50K is formed in a blazed reflective diffraction grating, and is provided with a metallic reflective film and dielectric multi-layered film made of such a material as aluminum or silver. The light 10a entering the prism 50K is reflected by the surface S2 to enter the surface S3 having a reflective diffraction grating approximately in the perpendicular direction. The light having entered the surface S3 is emitted from the diffracted surface S2. Assume that the wavelengths of the light 10a entering the surface S1 are wavelengths λ1 and λ2 satisfying the formula (1). Then the diffraction angle α is given as α21>α22 . . . (3). Thus, the incident angle of light entering the diffraction grating 20a of the light propagation element 20 will be given as θ21<θ22 . . . (4).

The above description shows that, when the period of the reflective diffraction grating is adjusted, it is possible to cancel the formula (2) representing the relationship of the incident angle depending on the wavelength of the diffraction grating 20a of the light propagation element 20 (i.e., it is possible to correct colors). To be more specific, it is possible to adjust and set at least one of the period of the reflective diffraction grating and the period of the grading of the diffraction grating 20a provided on the surface S3 so that θ11=θ21 for wavelength λ1 and θ12=θ22 for wavelength λ2.

In actual practice, however, the prism 50 is made of the glass or resin whose thermal expansion coefficient is not zero. The shape is changed in response to the ambient temperature by the thermal expansion coefficient of the material.

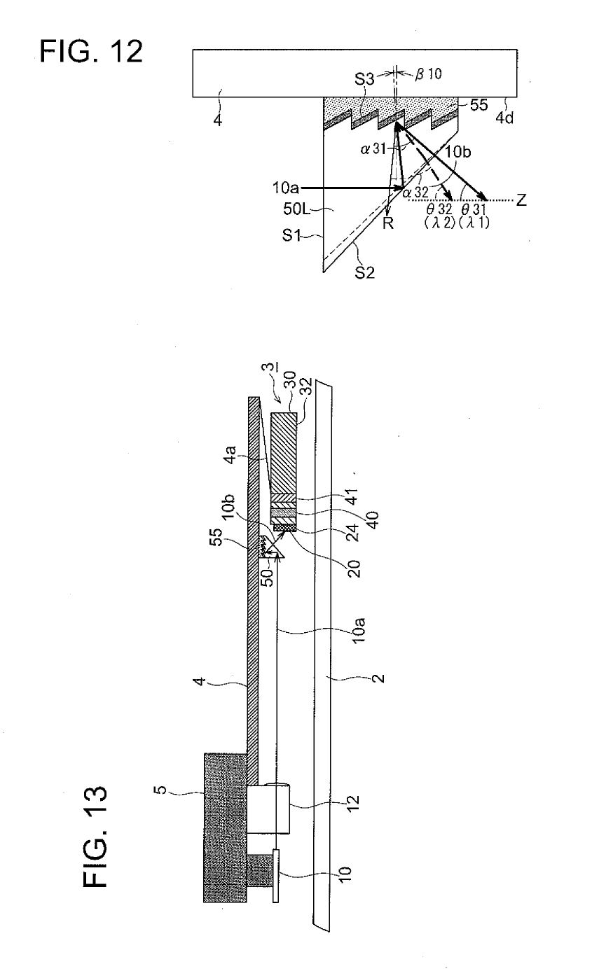

As a reference example, FIG. 12 shows the cross section of the periphery of the prism 50K fixed onto the suspension 4 of FIG. 13 by the adhesive agent 55. The prism 50L of FIG. 12 has the same shape as the prism 50A.

In FIG. 12, the resin-made prism 50L is fixed onto the lower surface 4d of the suspension 4 made of metal such as stainless steel by means of the adhesive agent 55. The broken line indicates the shape before the ambient temperature rises. The solid line indicates the shape after the ambient temperature has risen. The surface S3 provided with the diffraction grating is fixed onto the metallic suspension 4 having a thermal expansion coefficient smaller than that of the resin. Accordingly, there is no displacement in the shape wherein a problem may be raised by temperature rise. In actual practice, a displacement in the shape due to temperature rise also occurs to other than the positions indicated by the solid line. However, for ease of explanation, the characteristic displacement in the shape is shown in a simplified manner. In the following description, the broken line is also used to indicate the shape before the ambient temperature rises, and the solid line is used indicate the shape after the ambient temperature has risen. Further, the characteristic displacement in the shape is shown in a simplified manner, similarly to the above.

As illustrated in FIG. 12, when there is a temperature rise, the surface S3 is fixed in position without displacement in the shape. However, the prism 50L expands. As shown by the dotted line and solid line, there is an increase in the inclination of the surface S2 as a reflective surface, and the incident angle is reduced. Thus, the light 10a entering the surface S1 undergoes a change in the angle when reflected from the surface S2. The incident angle which was approximately perpendicular (zero) to the diffraction grating surface before temperature rise changes to β10 after temperature rise. Since there is no change in the pitch between diffraction gratings of the surface S3, the diffraction angle α is the same as the value shown in FIG. 11, and remains unchanged. To be more specific, α31=α21, and α32=α22. Thus, if 0-th order light direction R due to the diffraction grating has inclined by β10 as compared to the level before temperature rise, the incident angles θ31 and θ32 with respect to wavelengths λ1 and λ2 of the light entering the light propagation element 20 are increased over the angles before temperature rise. To be more specific, θ31>θ21, and θ32>θ22. An increase of these incident angles θ31 and θ32 over the angles before temperature rise is applicable to all the wavelengths of the light 10a entering the prism 50L, without being restricted to a specific wavelength of the light 10a. As a result, even if the light 10a from the light source is subjected to color-correction by the prism 50L, the incident angle of the light entering the light propagation element 20 may deviate from the optimum angle, and light coupling efficiency may be reduced. This may cause a failure in stable optical recording.

The present embodiment has been obtained from the concentrated study efforts made by the present inventors to find out the way of fixing the prism equipped with a diffraction grating to the suspension 4 to ensure that the incident angle of the light entering the light propagation element 20 does not deviate from the optimum level.

In the prism 50A of FIG. 5, the light 10a enters the surface S1, and the incoming light is reflected by the surface S2 as a reflective surface. The reflected light is diffracted by the surface S3 as the diffraction grating surface equipped with the diffraction grating (reflective diffraction grating), and is emitted from the surface S2. The light 10b emitted from the surface S2 enters the diffraction grating 20a for coupling light with the light propagation element 20, at a prescribed incident angle. This light is convey led into the waveguide light, which is propagated to the lower portion of FIG. 4 (in the direction of arrow mark 25).

From the formula (1) representing the relationship between wavelengths λ1 and λ2, the rotation angle θ is:

α51>α52 (5)

Thus, the incident angle of the light entering the diffraction grating 20a is given as:

θ51<θ52 (6)

The dependency of the incident angle on the wavelength of the diffraction grating 20a, shown in the formula (2), can be cancelled by adjusting the period of the diffraction grating provided on the surface S3 of the prism 50A.

To ensure that the deflecting angle of the light 10b emitted from the prism 50A will not be deviated by temperature fluctuation, the surface S1 is fixed by adhesive agent or the like on the fixing plate 42 which is the fixing member provided with a suspension 4, as shown in FIG. 5. To put it more specifically, part of the suspension 4 is slit and bent to form a fixing plate 42, to which the surface S11 of the prism 50A is fixed. In this case, the fixing plate 42 can be another member fixed onto the suspension 4. In this example, the fixing plate 42 is a metallic plate having a surface perpendicular to the optical axis of the light 10a. The surface S3 and lower surface 4d of the suspension 4 are in contact with each other in such a way that they are slightly in touch with each other, without the surface S3 being fixed to the suspension 4. Thus, the prism 50A is fixed to the suspension 4 in such a way that only the surface S1 restricts the displacement due to the temperature change. The surface S3 as a diffraction gating surface, and the surface S2 as a reflective surface can be freely displaced by the temperature change, without being fixed.

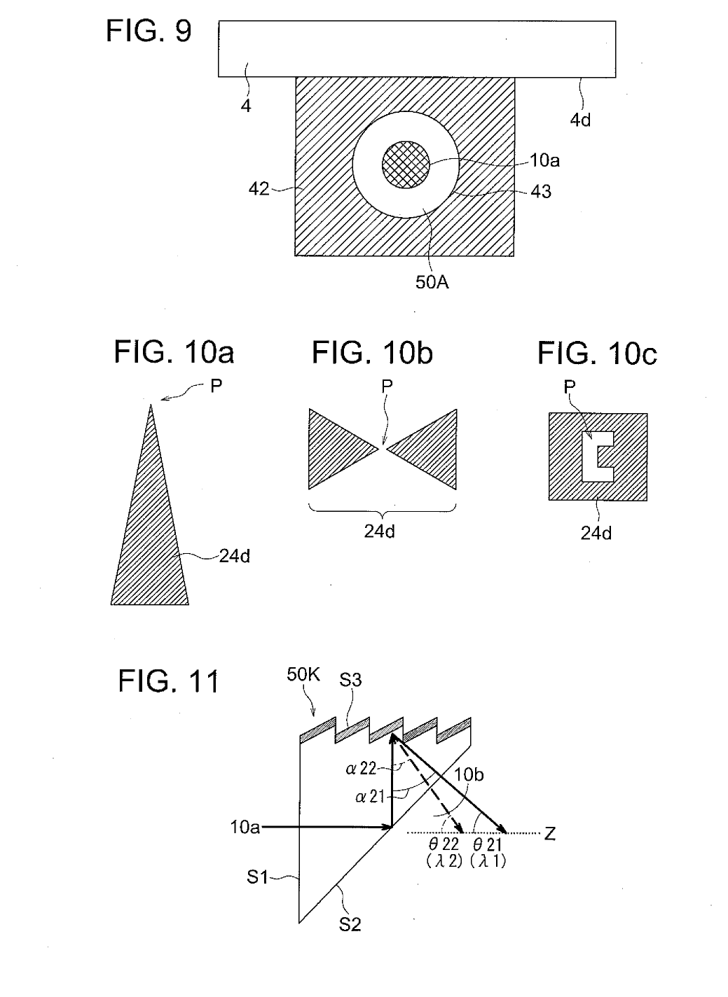

The fixing plate 42 fixed with the surface S1 is provided with an opening that allows the flux of light 10a to pass through the prism 50A without being adversely affected. FIG. 9 shows the prism 50A fixed to the fixing plate 42 as viewed from the side of the fixing plate 42.

The fixing plate 42 is a frame-like member equipped with an opening 43 for allowing entry of the light 10a. To minimize the displacement of the surface SI due to temperature change, means are preferably taken to ensure that, except for the portion other than the opening 43, the surface S1 will not be exposed, and the surface S1 is preferably fixed to the fixing plate 42 wherever possible. Minimizing the displacement of the surface S1 provides the sufficient displacement effect of the freely displaceable reflective surface and diffraction grating surface.

The thermal expansion coefficient of the material constituting the fixing plate 42 minimizes the geometrical displacement of the surface S1, and is preferably smaller than the thermal expansion coefficient of the material constituting the prism 50A. Further, the fixing plate 42 is preferred to have rigidity higher than that of the resin. Thus, the fixing plate 42 is preferably made of metals such as stainless steel. The rigidity can be enhanced by increasing the thickness of the plate or by designing such a structure that both edges of the fixing surface wherein the surface S1 is fixed are bent approximately perpendicular to the fixing surface. Enhanced rigidity of the fixing plate 42 prevents fixing plate 42 from being deformed due to the thermal expansion of the prism 50A. Enhanced rigidity also prevents the surface S1 as the fixing surface of the prism 50 from being inclined with respect to the optical axis. To prevent the fixing plate 42 itself from being inclined, the fixing plate 42 is preferably fixed to the suspension 4 with a high degree of rigidity.

In the prism 50A, as described above, the surface S1 as a light input surface is fixed to the fixing plate 42, while the surface S3 equipped with a diffraction grating and surface S2 as a reflective surface are not fixed. If the ambient temperature has arisen under this condition and the thermal expansion coefficient of the fixing plate 42 is less than the thermal expansion coefficient of the prism 50A, the prism 50A will be displaced in such a way as to expand in the direction of optical axis of the light 10a, as illustrated by the dotted line representing the state before temperature rise, and the solid line representing the state after temperature rise. The prism 50A does not expand in the direction perpendicular to the optical axis of the light 10a, as shown in FIG. 12. Thus, differently from the case of FIG. 12, the inclination of the surface S2 as a reflective surface is reduced, and the incident angle of the light 10a is increased. The incident angle having been approximately perpendicular to the surface S3 equipped with a diffraction grating before temperature rise changes to an angle β5 in the direction opposite that in the case of FIG. 12. This causes the 0-th order light direction R due to diffraction grating to be inclined by β5 with reference to the level before temperature rise. This change reduces the incident angles θ51 and θ52 of the light entering the light propagation element 20.

In the meantime, the surface S3 equipped with a diffraction grating expands and extends in the direction of grating pitch along the lower surface 4d of the suspension 4, whereby the period of the diffraction grating is increased and the diffraction angle α is reduced. To be more specific, α51<α21, and α52<α22. The incident angles θ51 and θ52 of the light entering the light propagation element 20 are increased.

Thus, the amount of change in the inclination of the surface S2 and the amount of change in the period of the diffraction grating of the surface S3 can be made to have such relationship as to mutually cancel out the impact on the change in the incident angle of light entering the light propagation element 20.

Accordingly, in the incident angle of the light entering the light propagation element 20 due to temperature change, if the amount of inclination of the surface S2 and the amount of cyclic change of the diffraction grating of the surface S3 are set so as to cancel out each other, the deflecting angle in the prism 50A does not fluctuate, without depending on temperature change. Thus, the incident angles θ51 and θ52 of the light entering the light propagation element 20 are not changed by temperature change, and θ51=θ21 and θ52=θ22 can be ensured. This arrangement provides stable photo-coupling to the light propagation element 20, and allows stable optical recording to be performed by the optical recording head 3.

When selecting the material for constituting the prism 50, this arrangement eliminates the need of giving special consideration to select a material characterized by the smallest thermal expansion coefficient. This increases the range of material selection and provides designing and manufacturing advantages.

The prism 50B of FIG. 6 is another specific example of the prism equipped with reflective diffraction grating. In the prism 50B, the light 10a enters the surface S1, and the incoming light is reflected by the surface S2. The reflected light is diffracted by the surface S3 equipped with the diffraction grating (reflective diffraction grating), and is outputted from the surface S2. The light 10b coming out of the surface S2 enters the diffraction grating 20a of the light propagation element 20 at a prescribed incident angle, and is converted into the waveguide light, which is then propagated downward (in the direction of arrow mark 25) in FIG. 4.

The prism 50B is fixed to the fixing plate 42 by the surface S1 as a light input surface, similarly to the case of the prism 50A. A gap is provided between the surface S3 as a diffraction grating and suspension 4 to ensure that the surface S3 will not touch the suspension 4, even when the surface S3 is extended and displaced by the thermal expansion.

As described above, in the prism 50B, the surface S1 as a light input surface is fixed to the fixing plate 42, while the surface S3 as a diffraction grating surface and the surface S2 as a reflective surface are not fixed. This structure allows free displacement to be performed by temperature change. If the ambient temperature has arisen under this condition and the thermal expansion coefficient of the fixing member is less than the thermal expansion coefficient of the prism 50B, the prism 50B will be displaced in shape in such a way as to incline toward the suspension 4 and to extend in the direction of optical axis of the light 10a, as illustrated by the dotted line representing the state before temperature rise, and the solid line representing the state after temperature rise.

Thus, differently from the case of FIG. 5, the inclination of the surface S2 as a reflective surface is increased, and the incident angle of the light 10a is decreased. The incident angle having been approximately perpendicular to the surface S3 as a diffraction grating before temperature rise changes in the direction opposite that in the case of FIG. 5. This increases the incident angles θ51 and θ52 of the light entering the light propagation element 20.

The surface S3 provided with a diffraction grating is extended in the direction of grating pitch by thermal expansion, and is inclined toward the suspension 4 at the same time. The surface S3 as a diffraction grating surface which the light 10a reflected by the surface S2 enters is inclined in the counterclockwise direction toward the surface of paper, as shown in FIG. 6. This change reduces the incident angles θ51 and θ52 of the light entering the light propagation element 20. Reference numeral β6 is used to indicate the incident angle of the light reflected from the surface S2 with reference to the surface S3 as the inclined diffraction grating surface.

In the specific example, the amount of change due to the inclination of the surface S3 is set to be greater than the amount of change due to the inclination of the surface S2 in the incident angles θ51 and θ52. To be more specific, the amount of change in the inclination of the surface S3 is greater than the amount of change in the inclination of the surface S2. Thus, the changes in the inclinations of surface S2 and surface S3 reduce incident angles θ61 and θ62 of the light entering the light propagation element 20, as a result.

As the diffraction grating of the surface S3 expands and extends in the direction of grating pitch, the period of the diffraction grating is increased, and the diffraction angle α is reduced. To be more specific, α61<α21 and α62<α22. Thus, the incident angles θ61 and θ62 of the light entering the light propagation element 20 are increased.

Thus, the amounts of changes in the inclinations of the surface S2 and surface S3 and the amount of change in the period of the diffraction grating can be made to have such relationship as to mutually cancel out the impact on the change in the incident angle of light entering the light propagation element 20.

Accordingly, in the incident angle of the light entering the light propagation element 20 due to temperature change, the amounts of changes in the inclinations of the surface S2 and surface S3 and the amount of change in the period of the diffraction grating of the surface S3 are set so as to cancel out each other. This ensures that the deflecting angle in the prism 50B does not change without depending on the temperature change. Thus, θ61=θ21 and θ62=θ22 can be obtained without incident angles θ61 and θ62 of the light entering the light propagation element 20 being changed by temperature changes. This arrangement ensures stable photo-coupling on the light propagation element 20, and allows stable optical recording to be performed by the optical recording head 3.

The prism 50C of FIG. 7 represents another specific example of the prism equipped with a transmission type diffraction grating. In the prism 50C, the light 10a enters the surface S1 and the inputted light is reflected from the surface S2. The reflected light is diffracted and emitted from the surface S3 provided with a diffraction grating (transmission type diffraction grating). The light 10b emitted from the surface S3 enters the diffraction grating 20a of the light propagation element 20 at a prescribed incident angle, and is converted to a waveguide light, which is then propagated downward (in the direction of arrow mark 25) in FIG. 4.

The prism 50C is fixed to the fixing plate 42 by the surface S1 as a light input surface, similarly to the case of the prism 50A. Further, the surface S4 facing the surface S3 equipped with the diffraction grating is fixed to the lower surface 4d of the suspension 4.

As described above, in the prism 50C, the surface S1 as a light input surface is fixed to the fixing plate 42, and the surface S4 is fixed to the suspension 4, whereas the surface S3 as a diffraction grating surface and surface S2 as a reflective surface are not fixed. This structure allows free displacement to be performed by temperature change. If the ambient temperature has arisen under this condition and the thermal expansion coefficient of the fixing member and suspension 4 is less than the thermal expansion coefficient of the prism 50C, the prism 50C will be displaced in shape in such a way as to be extended in the direction of optical axis of the light 10a, as illustrated by the dotted line representing the state before temperature rise, and the solid line representing the state after temperature rise in FIG. 7.

This increases the inclination of the surface S2 as the reflective surface, and reduces the incident angle of the light to the surface S3 as the diffraction grating surface by angle β7. This change reduces the incident angles θ1 and θ72 of the light entering the light propagation element 20.

The diffraction grating of the surface S3 expands and extends in the direction of grating pitch, whereby the period of the diffraction grating is increased and the diffraction angle α is reduced. To be more specific, α71<α21, and α72<α22. The incident angles θ71 and θ72 of the light entering the light propagation element 20 are increased.

Thus, the amount of change in the inclination of the surface S2 and the amount of change in the period of the diffraction grating of the surface S3 can be made to have such relationship as to mutually cancel out the impact on the change in the incident angle of light entering the light propagation element 20.

Accordingly, in the incident angle of the light entering the light propagation element 20 due to temperature change, the amount of change in the inclination of the surface S2 and the amount of change in the period of the diffraction grating of the surface S3 are set so as to cancel out each other. This ensures that the deflecting angle in the prism 50C does not change without depending on the temperature change. Thus, θ71=θ21 and θ72=θ22 can be obtained without incident angles θ71 and θ72 of the light entering the light propagation element 20 being changed by temperature changes. This arrangement ensures stable photo-coupling on the light propagation element 20, and allows stable optical recording to be performed by the optical recording head 3.

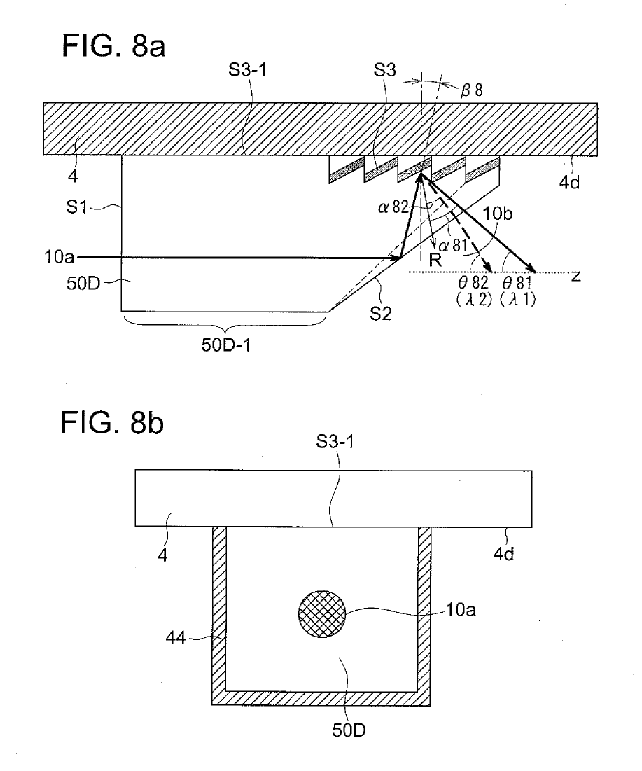

The prism 50D of FIG. 8a represents the prism 50A of FIG. 5 additionally provided with the columnar section 50D-1 wherein the portion having the same cross section (quadrilateral section) as the surface S1 of the prism 50A extends in the direction of the inputted light 10a. The light 10a enters the surface S1 and the inputted light and passes through the columnar section 50D-1. This light is reflected from the surface S2 located at the rear on the light path, and the reflected light is diffracted by the diffraction grating (transmission type diffraction grating) installed on the surface S3, and is emitted from the surface S2. The light 10b emitted from the surface S2 enters the diffraction grating 20a of the light propagation element 20 at a prescribed incident angle, and is converted to a waveguide light, which is then propagated downward (in the direction of arrow mark 25) in FIG. 4.

In the prism 50D, the lower surface 4d of the suspension 4 as a fixing member in this case fixes the surface S3-1 of the part not provided with the diffraction grating of the surface S3 perpendicular to the deflecting surface (surface parallel to the surface of paper in FIG. 8a) for deflecting the light 10a on the side surface of the columnar section 50D-1. The diffraction grating surface of the surface S3 and surface S2 as a reflective surface are not fixed in position. This structure allows free displacement to be performed by temperature change.

FIG. 8b shows the prism 50D as viewed from the side that the light 10a enters. Around the columnar section 50D-1, as shown in FIG. 8b, the frame member 44 made of such a metal as stainless steel, the same material as that of the suspension 4, having the thermal expansion coefficient smaller than that of the material constituting the prism 50D, is covered with the columnar section 50D-1 in contact therewith. This arrangement reduces the thermal expansion of the columnar section 50D-1. The columnar section 50D-1 and frame member 44 can be fixed with each other using an adhesive agent or the like.

If the ambient temperature has arisen under this condition and the thermal expansion coefficient of the suspension 4 is less than the thermal expansion coefficient of the prism 50D, the prism 50D will be displaced in such a way as to expand in the direction of optical axis, as illustrated in FIG. 8a by the dotted line representing the state before temperature rise, and the solid line representing the state after temperature rise. Thus, the inclination of the surface S2 as a reflective surface is reduced, and the incident angle of the light 10a is increased. The incident angle having been approximately perpendicular to the diffraction grating of the surface S3 before temperature rise changes to an angle β8. This change reduces the incident angles θ81 and θ82 of the light entering the light propagation element 20.

The diffraction grating of the surface S3 expands and extends in the direction of grating pitch along the lower surface 4d of the suspension 4, whereby the period of the diffraction grating is increased and the diffraction angle α is reduced. To be more specific, α81<α21, and α82<α22. The incident angles θ81 and θ82 of the light entering the light propagation element 20 are increased.

Thus, the amount of change in the inclination of the surface S2 and the amount of change in the period of the diffraction gating of the surface S3 can be made to have such relationship as to mutually cancel out the impact on the change in the incident angle of light entering the light propagation element 20.

Accordingly, in the incident angle of the light entering the light propagation element 20 due to temperature change, the amount of change in the inclinations of the surface S2 and the amount of change in the period of the diffraction grating of the surface S3 are set so as to cancel out each other. This ensures that the deflecting angle in the prism 50D does not change without depending on the temperature change. Thus, θ81=θ21 and θ82=θ22 can be obtained without incident angles θ81 and θ82 of the light entering the light propagation element 20 being changed by temperature changes. This arrangement ensures stable photo-coupling on the light propagation element 20, and allows stable optical recording to be performed by the optical recording head 3.

The aforementioned embodiments relate to the photo-assisted magnetic recording head and photo-assisted magnetic recording device. The major structures of these embodiments can be used in the optical recording head and optical recording device wherein an optical recording disk is used as a recording medium. In this case, the magnetic recording section 40 and magnetic reproduction section 41 provided on the slider 30 are not necessary.

### DESCRIPTION OF REFERENCE NUMERALS

1. Enclosure
2. Disk
3. Optical recording head
4. Suspension
5. Arm
10. Light source
10a. 10b. Light
12. Lens
20. Light propagation element
21. Core layer
22. Lower clad layer
23. Upper clad layer
24. Bottom end surface
24d. Plasmon antenna
26, 27. Side surface
20a. Diffraction grating
30. Slider
32. Air bearing surface
40. Magnetic recording section
41. Magnetic reproduction section
42. Fixing plate
50, 50A, 50B, 50C, 50D, 50K, 50L. Prism
100. Optical recording device
C. Axis
F. Focal point
R. 0-th order light direction

1. An optical device comprising;
an optical element for deflecting an incident light; and
a fixing member for fixing the optical element;
wherein the optical element has a reflective surface for deflecting the incident light and a diffraction grating surface for deflecting the incident light;
the optical element is fixed on the fixing member so as to restrain displacement due to a temperature change at portions thereof other than the reflective surface and the diffracting grating surface of the optical element, under a condition that a displacement due to the temperature change on the reflective surface and the diffraction grating surface is kept in a free state; and,
a change in the deflecting angle of the incident light caused by a change in inclination due to the displacement on the reflective surface and the diffraction grating surface is suppressed by a change in the diffraction angle caused by a change of the period of the diffraction grating due to the displacement in the diffraction grating surface.

2. The optical device of claim 1,
wherein a thermal expansion coefficient of a material constituting the fixing member is smaller than a thermal expansion coefficient of a material constituting the optical element.

3. The optical device of claim 2,
wherein the material of the fixing member is metallic and the material of the optical element is resinous.

4. The optical device of claim 1,
wherein a surface of the optical element allowing entry of the incident light is fixed to the fixing member.

5. The optical device of claim 1,
wherein the optical element further comprises a columnar member with a surface allowing entry of the incident light;
the reflective surface and the diffraction grating surface is provided at a position for receiving the light which passes through the columnar member; and
the optical element is fixed to the fixing member on a side surface of the columnar member.

6. The optical device of claim 5,
wherein, around the columnar member, a frame member made of the material having a thermal expansion coefficient smaller than a thermal expansion coefficient of the material constituting the optical element is covered in contact with the side surface of the columnar member.

7. An optical recording head for optically recording information on a recording medium, wherein the optical recording head comprises;
a slider provided with a light propagation element for irradiating the recording medium with light;
a suspension for supporting the slider so as to move the slider relative to the recording medium; and
the optical device of claim 4;
wherein the fixing member is fixed to the suspension, and the optical element allows a deflected light to enter the light propagation element.

8. An optical recording head for optically recording information on a recording medium, wherein the optical recording head comprises;
a slider provided with a light propagation element for irradiating the recording medium with light;
a suspension for supporting the slider so that the slider can be moved relative to the recording medium; and,
the optical device of claim 5;
wherein the fixing member is the suspension, and the optical element allows a deflected light to enter the light propagation element.

9. The optical recording head of claim 7,
wherein the light propagation element further comprises;
a waveguide for propagating light; and
a grating coupler for coupling light into the waveguide; and
the optical element allows light to enter the grating coupler.

10. An optical recording device comprising;
a light source;
the optical recording head of claim 9, allowing the light of the light source to enter the optical element; and
the recording medium.
